(19) United States
(12) Patent Application Publication
(10) Pub. No.: US 2009/0150340 A1
(43) Pub. Date: Jun. 11, 2009

(54) METHOD AND APPARATUS FOR CONTENT ITEM RECOMMENDATION

(75) Inventors: Nicolas Lhuillier, Versailles (FR); David Bonnefoy, Gilly sur Isere (FR); Makram Bouzid, Palaiseau (FR); Kevin C. Mercer, Wantage (GB)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/950,605

(22) Filed: Dec. 5, 2007

(51) Int. Cl. G06F 7/06

(52) U.S. Cl. 707/3; 707/E17.014

(57) ABSTRACT

An apparatus for content item recommendation, such as a Digital Video Recorder, comprises a grouping unit (105) for grouping user ratings for content items into rating groups in response to a content item match criterion. A receiver (109) receives content item data for a plurality of content items and a first recommendation unit (107) generating a first set of content item recommendations. An association unit (111) then determines an associated rating group of the rating groups for each content item recommendation of the first set and a second recommendation unit (113) generates a second set of content item recommendations from the first set in response to a rating group distribution measure for the second set. The invention may allow improved recommendation of content items which is aligned with user preferences yet provide a desired diversity of the provided recommendation. The invention may in particular provide improved performance for multi-user devices.

### FIELD OF THE INVENTION

The invention relates to recommendation of content items and in particular, but not exclusively, to recommendation of television or radio programmes.

### BACKGROUND OF THE INVENTION

In recent years, the availability and provision of multimedia and entertainment content has increased substantially. For example, the number of available television and radio channels has grown considerably and the popularity of the Internet has provided new content distribution means. Consequently, users are increasingly provided with a plethora of different types of content from different sources. In order to identify and select the desired content, the user must typically process large amounts of information which can be very cumbersome and impractical.

Accordingly, significant resources have been invested in research into techniques and algorithms that may provide an improved user experience and assist a user in identifying and selecting content.

For example, Digital Video Recorders (DVRs) or Personal Video Recorders (PVRs) have become increasingly popular and are increasingly replacing conventional Video Cassette Recorders (VCRs) as the preferred choice for recording television broadcasts. Such DVRs (in the following the term DVR is used to denote both DVRs and PVRs) are typically based on storing the recorded television programmes in a digital format on a hard disk or optical disc. Furthermore, DVRs can be used both for analogue television transmissions (in which case a conversion to a digital format is performed as part of the recording process) as well as for digital television transmissions (in which case the digital television data can be stored directly).

Increasingly, devices, such as televisions or DVRs provide new and enhanced functions and features which provide an improved user experience. For example, televisions or DVRs can comprise functionality for providing recommendations of television programs to the user. More specifically, such devices can comprise functionality for monitoring the viewing/recording preferences of a user. These preferences can be stored in a user preference profile and subsequently can be used to autonomously select and recommend suitable television programs for viewing or recording. E.g. a DVR may automatically record programs which are then recommended to the user, for example by inclusion of the automatically recorded programmes in a listing of all the programmes recorded by the DVR.

Such functionality may substantially improve the user experience. Indeed, with hundreds of broadcast channels providing thousands of television programs per day, the user may quickly become overwhelmed by the offering and therefore may not fully benefit from the availability of content. Furthermore, the task of identifying and selecting suitable content becomes increasingly difficult and time-consuming. The ability of devices to provide recommendations of television programs of potential interest to the user substantially facilitates this process.

In order to enhance the user experience, it is advantageous to personalise the recommendations to the individual user. In this context, a recommendation consists in predicting how much a user may like a particular content item and recommending it if it is considered of sufficient interest. The process of generating recommendations requires that user preferences have been captured so that they can be used as input by the prediction algorithm.

There are two main techniques used to collect user preferences. The first approach is to explicitly obtain user preferences by the user(s) manually inputting their preferences, for example by manually providing feedback on content items that the user(s) particularly liked or disliked. The other approach is to implicitly obtain user preferences by the system monitoring user actions to infer their preferences.

Although these techniques may be suitable for many single-user environments, they are not particularly well suited to many other environments or to multi-user environments.

For example, most of the known recommendation approaches are not ideal in the context of television viewing. A television or video recorder, such as specifically a DVR, is commonly a multi-user device and the activity of watching television is characterised by being a low effort and highly passive activity. In this context, although users ask for individual recommendations, creating individual user profiles tends to not be easy or effective.

Specifically, explicit elicitation of preferences is not effective as it is difficult for users to precisely describe their tastes. Furthermore, the user will typically consider it cumbersome and tedious to manually initialise and maintain a user preference profile.

Explicit feedback on programmes is impractical in multi user environments as it requires the user to be identified before the programme feedback can be recorded in order to allow the system to differentiate between the preferences of the different users.

Also, implicit learning of preferences tends not to be effective as current users would need to be automatically identified and in addition implicit learning does not work well in contexts such as radio or television since the radio or television is often used as a background medium and therefore may play programmes that are not of interest to the user(s).

Known recommendation systems accordingly tend to be inflexible and/or require a significant manual involvement of the user(s). Furthermore, conventional recommenders tend to be complex and especially require complex algorithms for manipulating user rating inputs to generate personalised content item recommendations, especially in multi user environments.

Conventional approaches for such multi-devices specifically tend to fall into two categories:
1. The device is based on manual identification of the individual user. Specifically, the device requires the user to login or otherwise identify themselves to the user. This identification is used both when entering implicit or explicit preferences and when obtaining recommendations.
2. The device considers the users as a single group of homogeneous users. In the approach, all users are treated identically and recommendations are based on the preferences of a group as a whole without personalisation for the individual system. For example, a common user preference profile is used of all users.

The first approach is typically incompatible with low user interaction, casual user activities such as watching television as it requires inconvenient operations to be frequently performed by the individual user. Hence, the approach is too cumbersome for many applications.

The second approach tends to lead to suboptimal user personalisation. In particular, it may lead to the preferences of some users overshadowing the preferences of other users such that the provided group based recommendations tend to not include sufficient recommendations for some users.

Therefore, an improved system for content item recommendation would be advantageous. In particular, a system allowing an improved user experience, increased flexibility, reduced complexity, improved suitability for multi-user environments, reduced need for user inputs, improved personalisation for the individual user of a multi-user device and/or improved performance would be advantageous.

### SUMMARY OF THE INVENTION

Accordingly, the Invention seeks to preferably mitigate, alleviate or eliminate one or more of the above mentioned disadvantages singly or in any combination.

According to an aspect of the invention there is provided an apparatus for content item recommendation, the apparatus comprising: a grouping unit for grouping user ratings for content items into rating groups in response to a content item match criterion; a receiver for receiving content item data for a plurality of content items; a first recommendation unit for generating a first set of content item recommendations; an association unit for determining an associated rating group of the rating groups for each content item recommendation of the first set; and a second recommendation unit for generating a second set of content item recommendations from the first set in response to a rating group distribution measure for the second set.

The invention may allow an improved recommendation of content items. Specifically, the invention may e.g. provide increased flexibility and/or reduced complexity of the recommendation. The invention may allow improved diversity of the provided recommendations, and may for example increase the likelihood of the generated recommendations reflecting more of a users interest and/or interests of more users for a multi-user implementation. In particular, for a multi user embodiment, the invention may provide an improved likelihood that the generated recommendations include recommendations for all users.

The invention may allow personalised recommendation while ensuring a desired variety and/or diversity in the generated set of recommendations.

The invention may allow facilitated implementation and/or operation in many embodiments. For example, the apparatus may allow efficient recommendations to be generated based on user ratings provided anonymously for a plurality of users.

In particular, the invention may in many embodiments allow improved multi user recommendations to be generated while allowing a simple operation and in particular without requiring any identification of the individual user. For example, the invention may allow content recommendation in multi-user systems which can reflect individual preferences for the individual user without requiring that the user ratings are correlated to specific users or are individually manipulated for each user.

The user ratings may e.g. comprise user ratings for a plurality of users and may be anonymous user ratings. In particular, the user ratings may be user ratings which comprise no identity information of the originating user(s) of the user ratings.

At least some of the user ratings may comprise at least one of content item description data and preference data (which may be implicit or explicit).

The invention may allow facilitated operation and/or an improved user experience. For example, the invention may allow a flexible and personalised recommendation without requiring substantial involvement by the individual users.

The content items may specifically be television programmes or radio programmes. The apparatus may specifically be a television, a DVR or a media server.

According to another aspect of the invention there is provided a method of content item recommendation, the method comprising: grouping user ratings for content items into rating groups in response to a content item match criterion; receiving content item data for a plurality of content items; generating a first set of content item recommendations; determining an associated rating group of the rating groups for each content item recommendation of the first set; and generating a second set of content item recommendations from the first set in response to a rating group distribution measure for the second set.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 is an illustration of an example of an apparatus for generating content item recommendations in accordance with some embodiments of the invention;

FIG. 2 is an illustration of an example of data manipulation by the apparatus of FIG. 1; and

FIG. 3 is an illustration of an example of a method of generating content item recommendations in accordance with some embodiments of the invention.

### DETAILED DESCRIPTION OF SOME EMBODIMENTS OF THE INVENTION

The following description focuses on embodiments of the invention applicable to a recommendation system for television programmes. However, it will be appreciated that the invention is not limited to this application but may be applied to many other content items including any data entity, stream or file that comprises presentation data for content that can be presented to a user including for example radio programmes, audiovisual files, music files etc.

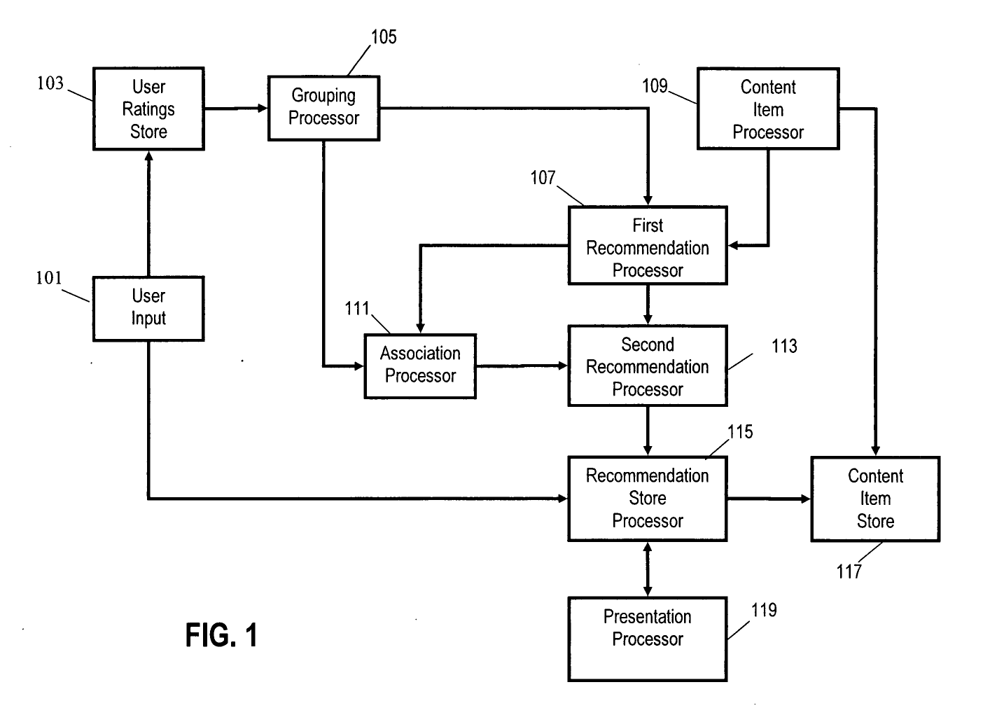

FIG. 1 is an illustration of a device for making content item recommendations in accordance with some embodiments of the invention. The device may for example be a DVR or a television.

The device of FIG. 1 comprises functionality for recommending content items to a user. Specifically, the device comprises functionality for generating recommendations for a user and for storing the recommended content items at a local storage. Specifically, the device may recommend television programmes to the user of the device and record these programmes when they are broadcast. The device uses an approach for selecting content items to store which is highly flexible, allows a high degree of personalisation yet ensures that a diverse spectrum of content items are stored. Specifically, the device uses a two-stage approach wherein user ratings are first used to generate personalised content recommendations e.g. for a group of users. A smaller set of recommendations is then selected while ensuring that sufficient diversity of the stored content is achieved. E.g. the second stage may seek to ensure that at least one content item is selected for each user.

The approach is based around an automatic clustering of user ratings which may provide a broad diversity of the content items that nevertheless matches the preferences of the user(s) without any explicit user identification being necessary. This approach may provide an efficient implementation with high flexibility and is in particular useful for multi-user environments wherein, possibly anonymous, user ratings may be received from a plurality of users.

The following description will focus on a multi-user device and scenario such as a DVR used by a plurality of members of a household (e.g. all members of a family). However, it will be appreciated that the described principles may also be applied to a single user device.

The device comprises a user input 101 that can receive manual inputs from one or more users. Specifically the user input 101 can receive feedback of the user preferences for various content items. As an example, a user watching or playing back a specific television programme can manually input how he rates the program. This rating can be provided without any identification of the user, i.e. the provided user rating can be anonymous.

The user input 101 is coupled to a user ratings store 103. When a user rating/preference is received from the user input 101, a user rating record comprising the user preference value and content item characterising data describing the contents are stored in the user ratings store 103.

The user rating record can for example store the user preference as a number between 1 and 10 as well as characterising (meta)data such as the genre of the television programme, the title of the television programme, the duration of the television programme, people involved in the television programme (such as actors or directors) etc.

In the example, the device is a multi-user device that may be used by many different users. Furthermore, the user preferences are inputted without any identification of the specific user that is providing the data. Accordingly, the user rating records stored in the user rating store 103 are anonymous user ratings and the records do not comprise any information of the identity of the user who provided the input. Thus, the user ratings are provided without requiring cumbersome or inconvenient manual user identification. Accordingly, a user can simply use the DVR without needing to log-in or otherwise identify himself or herself.

Thus, the DVR collects user preferences which can be explicit (e.g. a user rates the programme via dedicated buttons on the remote) and/or can be implicit (e.g. the DVR monitors the users' watching patterns and infers preferences therefrom). The stored user preferences/ratings are anonymous and are merged together so that the stored user ratings are a group of multi-user ratings.

The user ratings store 103 is coupled to a grouping processor 105 which is arranged to cluster or group user rating records into groups of user ratings. The grouping of the user ratings is performed in response to a content item match criterion which may be any suitable match criterion that allows a grouping of content items into groups having desirable common characteristics. The match criterion may be a simple similarity criterion for specific characteristics of the user ratings or may e.g. be a (potentially complex) clustering algorithm.

For example, the content item match criterion may require that a content characteristic, such as a genre or actor, is the same for all the content items in a given group. Additionally or alternatively, the content item match criterion may require that user preferences for content items in the same group are the same or similar. For example, the grouping processor 105 can generate groups as content items corresponding to for example movies the users like, movies the users do not like, actors the users like, actors the users do not like, etc.

In more complex embodiments, the grouping processor 105 may for example group the content items by using a clustering algorithm such as a k-means or isodata clustering algorithm.

A k-means clustering algorithm initially defines k clusters with given initial parameters. The user rating records are then matched to the k clusters. The parameters for each cluster are then recalculated based on the user rating records that have been assigned to each cluster. The algorithm then proceeds to reallocate the user rating records to the k clusters in response to the updated parameters for the clusters. If these operations are iterated a sufficient number of times, the clustering converges resulting in k groups of content items having similar properties.

In the specific example, the DVR regularly regroups or re-clusters preferences by similarity in order to create clusters using a clustering algorithm, such as the K-means algorithm, based on a similarity function which computes a measure of the similarity of two content items such as the (weighted) sum of the similarity of their descriptive metadata (e.g. genre, channel, etc.):

$$similarity ( {P}_{1} , {P}_{2} ) = {\sum }_{i ∈ \{ metadata ( P ) \}} {α}_{i} \cdot {similarity}_{i} ( {P}_{i , 1} , {P}_{i , 2} )$$

The metadata can specifically represent content data such that the similarity measure and the clustering algorithm effectively implement a content item match criterion which includes a content match criterion. Thus, the resulting clusters contain content items that have relatively similar content.

In some embodiments, the user preference for each content item may also be taken into account by the clustering algorithm. For example, the similarity measure may also include a contribution indicating how closely matched the user ratings for the content items are. Thus, the clustering algorithm can effectively implement a content item match criterion which includes a user preference indication match criterion. Thus, the resulting clusters can contain content items that have been rated relatively similarly by the users.

The grouping processor 105 thus generates rating groups by clustering the user ratings (and associated content items) from the user ratings store 103. As the user ratings originate from a plurality of users and are anonymous, the generated user rating groups are common to a plurality of users.

The device furthermore comprises a first recommendation processor 107 which is coupled to the grouping processor 105. In addition, the first recommendation processor is coupled to a content item processor 109. The content item processor 109 receives information of various content items which are eligible to be recommended to a user and in the example also receives the broadcast of the content items themselves.

For example, the content item processor 109 can be provided with information of the television programmes that are to be received within a given time interval. Specifically the content item processor 109 can receive an Electronic Programme Guide (EPG) that indicates the television programmes that will be transmitted in, say, the next week. In addition to the time and titles of the television programmes, the EPG can contain further meta-data such as an indication of the genre, actors, directors etc.

The content item processor 109 can specifically include a conventional television broadcast receiver.

The first recommendation processor 107 is arranged to generate a first set of content item recommendations in response to the user ratings.

In the specific example, the generation of the first set of recommendations is based on the rating groups generated by the grouping processor 105 but it will be appreciated that in other embodiments the first set may be generated without consideration of these. Indeed, it will be appreciated that any generation of a set of recommendations may be used by the first recommendation processor 107 and that this generation need not necessarily be in response to the user ratings stored in the user ratings store 103.

However, in the example, the first recommendation processor 107 initially generates a set of recommendations for each of the user rating groups determined by the grouping processor 105. Thus, in the example, the first recommendation processor 107 processes each user rating group independently of the other user rating groups. For each user rating group, a list of recommendations is generated.

Specifically, for each user rating group, the first recommendation processor 107 compares each of the potential content items from the content item processor 109 to the characteristics of the user rating group. If the match is sufficiently close, the content item is considered to belong to this group and is accordingly considered to have a rating that can be determined from the user ratings of the group.

As a simple example, for a given user rating group, a user preference value can be set to correspond to the average of all the user preference values for the user rating records in the group. Thus, if the content item is found to match a group, it is included in the list of recommendations for that group and is assigned the rating of the group.

Accordingly, the first recommendation processor 107 generates a number of recommendation lists with each list comprising a number of content items that are considered to have characteristics matching the group.

Hence, when generating recommendations, the device retrieves the list of content available for the time period being considered (for instance via the EPG) and uses the groups to compute recommendations. For each piece of content, this is done by determining the closest group (e.g. using a similarity or distance function) and computing the recommendations for that group using a content matching algorithm and the programme ratings of this group. This process results in obtaining one list of recommendations per group. The first set of recommendations can then simply be determined as the set including all the recommendations generated, i.e. by combining the recommendations generated for the individual rating groups.

It will be appreciated that in practical systems, a complex recommendation algorithm, such as a reasoning algorithm based on a Naïve Bayes classifier will typically be used.

The DVR furthermore comprises an association processor 111 which is coupled to the grouping processor 105 and the first recommendation processor 107. The association processor 111 is arranged to determine an associated rating group for each content item recommendation of the first set of content item recommendations generated by the first recommendation processor 107.

The association processor 111 can specifically compare each content item included in the first set to each of the rating groups and evaluate a similarity measure for each of the rating groups. It can then associate/link the content item to the rating group for which the similarity measure has the highest value. The similarity value used can specifically be the same similarity value as that used when clustering the user ratings by the grouping processor 105.

In the specific example where the first recommendation processor 107 generates a separate list of recommendations for each cluster/rating group, the association processor 111 can simply link each content item recommendation of the first set to the rating group which originated the recommendation.

In the specific embodiment, each content item recommendation is associated with only a single rating group. However, it will be appreciated that in other embodiments, a plurality of rating groups may be associated with a single content item recommendation. For example, a content item recommendation may be associated with all rating groups for which the similarity measure is above a given threshold.

The first recommendation processor 107 is also coupled to a second recommendation processor 113. The second recommendation processor 113 is arranged to generate a second set of recommended content items from the first set of recommended content items. The generation of the second set is performed in response to a rating group distribution measure for the second set.

The second recommendation processor 113 can specifically select content item recommendations of the first set for the second set such that a measure of how broadly the resulting content item recommendations are distributed across the rating groups. It will be appreciated that any measure or indication reflecting the distribution of the content item recommendations of the second set across the rating groups can be used without detracting from the invention. A simple distribution measure is the number of rating groups that are represented by the content item recommendations in the second set. As another example, a distribution measure which reflects a variance of the number of content item recommendations of the second set associated with each rating group can be used. As another example, a distribution measure may be given as the lowest number of recommendations associated with a rating group.

As an example of how the second recommendation set may be generated, the second recommendation processor 113 can be arranged to select a predetermined number of content item recommendations from the first set by generating a rating group distribution measure for all possible selections of recommendations from the first set. The second recommendation processor 113 can then simply select the content item selection that results in a distribution measure closest to the desired value. For example, the selection that results in the highest distribution measure may be chosen.

As a more complex example, a preference value may be generated for each possible selection which takes into account both the user ratings and the resulting rating group distribution measure. For example, for each possible selection, an accumulated user rating value may be calculated for the selected content items and a weighted sum of the accumulated user rating and the distribution measure may be used as a preference value. The set of content items resulting in the highest preference value can then be chosen by second recommendation processor 113. By adjusting the relative weighting of the accumulated user rating and the distribution measure, a desired trade-off between targeted personalisation and diversity of the provided recommendations can be achieved.

In the example, the second recommendation processor 113 selects the recommendations for the second set such that a rating group distribution criterion is met. The rating group distribution criterion may for example be a requirement that the distribution measure exceeds a given threshold. Thus the second recommendation processor 113 can select the content item recommendations of the first set that will result in the highest accumulated user rating under the conditions that a minimum distribution across the different rating groups is achieved.

In some embodiments, the rating group distribution criterion can comprise a requirement that at least one content item is selected for each rating group for which a content item recommendation is included in the first set. Thus, in this example, the recommendations are selected based on the predicted user interest but are also selected to ensure that there is at least one programme recorded for each of the identified rating groups, thereby ensuring a desired degree of diversity and especially ensuring that all interests represented by a user rating group (for which the first recommendation processor 107 has generated a recommendation) are catered for in the resulting second set of recommendations.

Thus, the consideration of the rating group distribution when selecting the recommendations for the second set by the second recommendation processor 113 allows the system to automatically generate recommendations which not only reflect the user' preferences but also provide a desired degree of diversity. Furthermore, this diversity is aligned along the users' preferences and specifically ensures that recommendations are provided for a wide variety of specific preferences represented by the rating groups.

For example, for a single user DVR, the approach will increase the likelihood that recommendations are generated for more or all of the user's interests even if some of these interests have a much higher rating than other interests. Thus, the system can reduce the probability that some strong interests completely overshadow weaker interests. E.g. a user having a very high interest in football matches and a moderate interest in cars will be provided with recommendations of both television programmes related to football matches and television programmes related to cars rather than just programmes related to football matches. Accordingly, this will allow the user to always have the option of selecting a television programme suiting his current preference.

The provided advantages can be even more significant in a multi-user system. Specifically, in a single user system, the clustering of the grouping processor 105 results in rating groups aligned along different preferences of a single user. However, for a multi-user system, the clustering performed by the grouping processor 105 will also tend to separate out the individual preferences and interests of different users. For example, for a DVR used by a family, it is likely that one rating group will tend to be focused around e.g. children's programmes (of particular interest to the children of the family), another around e.g. sports programmes (of particular interest e.g. to the father), another around news programmes (of particular interest e.g. to the mother), another around movies (of particular interest e.g. to both parents) etc.

Accordingly, by generating recommendations such that an increasing number of clusters or rating groups are catered for, it is ensured that recommendations are provided for all users. Furthermore, this diversity can be achieved even if the DVR is predominantly used by only a subset of the users.

Hence, in a multi-user environment, the system allows an automatic alignment of recommendations along the individual user interests and allows recommendations to be generated which ensure that all users are sufficiently considered. Furthermore, this is achieved without requiring any additional identification to be provided by the individual users. Thus, an improved and facilitated user experience is provided by the described system.

The second recommendation processor 113 is coupled to a recommendation store processor 115 which is furthermore coupled to a content item store 117. The content item store 117 is coupled to the content item processor 109 and is fed the content items when these are received. Specifically, the content item store 117 receives the television programmes received by the content item processor 109 and the recommendation store processor 115 controls the content item store 117 such that the television programmes which are recommended in the second set of recommendations are recorded in the content item store 117. For this purpose, the content item store 117 may for example comprise a hard disk.

The recommendation store processor 115 is furthermore coupled to a presentation processor 119 and to the user input 101. The recommendation store processor 115 can, e.g. based on an explicit user request received by the user input 101, provide the second set of recommendations to the presentation processor 119. The presentation processor 199 then presents these recommendations to the user(s). For example, the presentation processor 119 can display a list of the recommended and stored television programmes on the display of a television.

In the specific example, at least one presentation characteristic for at least one recommendation is dependent on the associated user rating group(s). For example, the presentation processor 119 can assign a different font or colour to each user rating group and use this when presenting the recommendations. As another example, recommendations that are associated with the same rating group may be grouped together when presenting the recommendations. Such an approach will provide added information to the users and for example allow the individual user to quickly identify recommendations which are likely to be targeted to him as these may be grouped together.

In the example, the recommendation store processor 115 can furthermore receive a selection of one of the recommended content items from the user input 101 and can in response retrieve the selected content item from the content item store 117 and present it to the user via the presentation processor 119.

In some embodiments, the second recommendation processor 113 is arranged to adapt the number of recommendations included in the second set for individual rating groups depending on a user behaviour associated with the rating groups. Thus, depending on how content items associated with specific rating groups are consumed or otherwise used by the user(s), the second recommendation processor 113 may choose to increase or decrease the number of recommendations included in the second set for the individual rating groups.

For example, if the DVR detects that a relatively high number of content items are selected by the user for a specific rating group, the second recommendation processor 113 may increase the number of recommendations selected for that rating group in the future. In contrast, if content items associated with a specific rating group are rarely selected by the users, the number of recommendations included for this group may be reduced.

Alternatively or additionally, the number of recommendations included in the second set for a given rating group may be dependent on the number of user ratings which have been clustered together in this group. Thus, the number of recommendations for each cluster or rating group may be dependent on the size of that cluster or group. As the user ratings in the specific example can be generated implicitly by the user selecting stored content items, the size of the individual rating group may be a good indication of how frequently content items of that rating group are consumed by the users

In some embodiments, the second recommendation processor 113 is arranged to replace a recommendation for a content item that has been consumed by another content item which is associated with the same rating group as the one that was consumed. Thus, the system may automatically attempt to replace a consumed content item by a similar content item thereby continuously providing a set of recommendations that is aligned with the users preferences and interests.

It will be appreciated that in some embodiments, the DVR periodically generates new sets of recommendations as described previously.

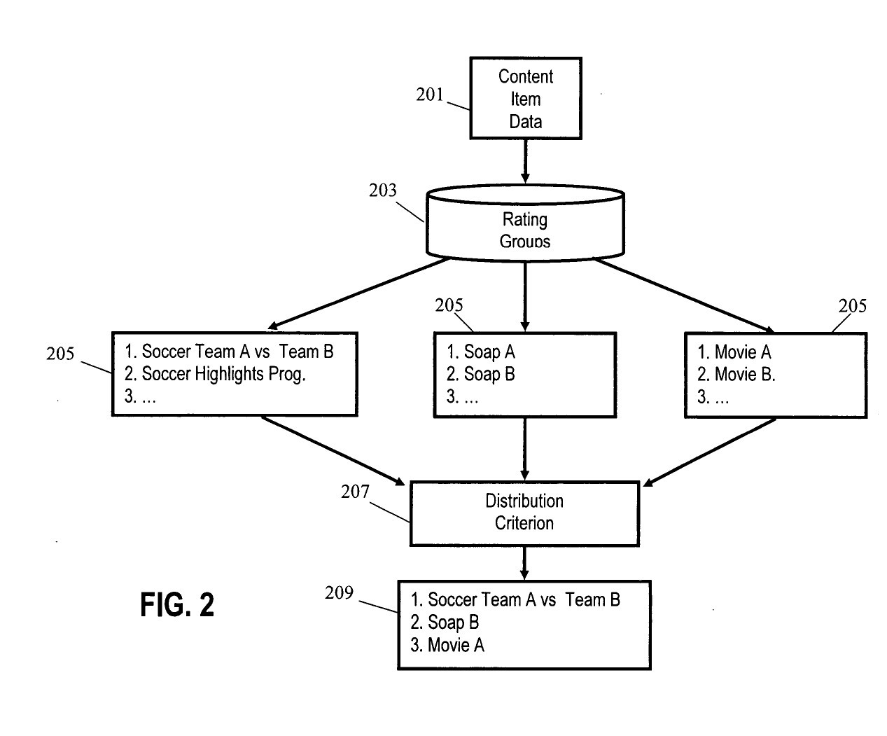

FIG. 2 illustrates an example of how data may be processed by the device of FIG. 1.

The device receives content item data 201 for example in the form of an EPG. The content item data 201 is compared to the rating groups 203 to generate a plurality of lists 205. In the specific example, one list of recommendations 205 is generated for each rating group. In the example, a first list corresponds to recommended sports programs, a second list corresponds to recommended soaps and a third list corresponds to recommended movies. The individual lists 205 are then processed with reference to the distribution measure or criterion 207. As a result, a single list of recommendations 209 is generated. This list is personalised and aligned with the interests of the user(s) yet provides a high degree of diversity and specifically may cater for the interests of all users of a multi-user device.

In the example, the generation of recommended content item lists is based entirely on information which is not specific or linked to any individual user but rather is associated with the entire group of users that use the device. Nevertheless, the system allows a recommendation set to be generated which reflects the individual preferences of each user. Furthermore, this processing is performed without requiring that all the data is processed or sorted according to the individual users thereby providing a system having low complexity yet generating flexible and accurate content item recommendation. Specifically, in some embodiments, the grouping of user ratings and the content item recommendations for each user rating group may be common for all users.

The specific described system provides a personalised television system which successfully fulfils two of the main requirements identified for users of such systems in that it provides personalised recommendations for all users of the system yet allows the television experience to remain casual and simple.

Furthermore, as preferences are grouped by similarity, one user can benefit from preferences expressed by another user. This can be a significant advantage as in many households several persons typically have overlapping preferences (e.g. the parents). The approach thus increases the number of preferences available to the system compared to systems where preferences are kept for individual users and therefore speeds-up the learning curve of this system and provides more accurate preferences.

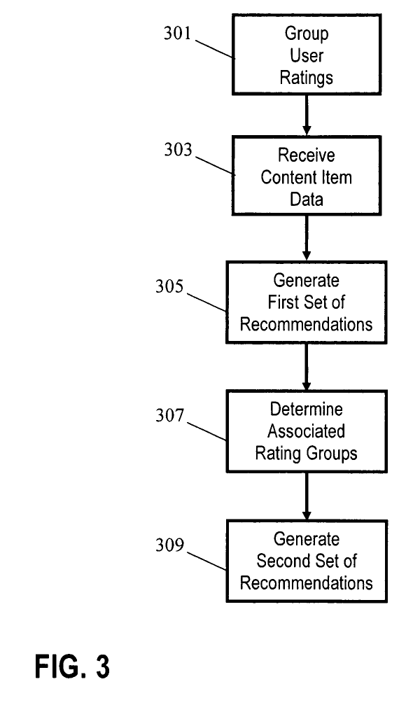

FIG. 3 illustrates an example of a method of content item recommendation in accordance with some embodiments of the invention.

The method initiates in step 301 wherein user ratings for content items are grouped into rating groups in response to a content item match criterion.

Step 301 is followed by step 303 wherein content item data for a plurality of content items is received.

Step 303 is followed by step 305 wherein a first set of content item recommendations is generated.

Step 305 is followed by step 307 wherein an associated rating group of the rating groups is determined for each content item recommendation of the first set.

Step 307 is followed by step 309 wherein a second set of content item recommendations is generated from the first set in response to a rating group distribution measure for the second set.

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processor or controllers. Hence, references to specific functional units are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims does not imply any specific order in which the features must be worked and in particular the order of individual steps in a method claim does not imply that the steps must be performed in this order. Rather, the steps may be performed in any suitable order.

1. An apparatus for content item recommendation, the apparatus comprising:
a grouping unit for grouping user ratings for content items into rating groups in response to a content item match criterion;
a receiver for receiving content item data for a plurality of content items;
a first recommendation unit for generating a first set of content item recommendations;
an association unit for determining an associated rating group of the rating groups for each content item recommendation of the first set; and
a second recommendation unit for generating a second set of content item recommendations from the first set in response to a rating group distribution measure for the second set.

2. The apparatus of claim 1 wherein the second recommendation unit is arranged to select content item recommendations for the second set from the first set such that the associated rating groups of the second set meet a rating group distribution criterion.

3. The apparatus of claim 2 wherein the rating group distribution criterion comprises a requirement that at least one content item is selected for each rating group for which a content item recommendation is included in the first set.

4. The apparatus of claim 1 further comprising a unit for adapting a number of recommendations included in the second set for a first rating group in response to a user behaviour associated with the first rating group.

5. The apparatus of claim 4 wherein the user behaviour is a content item consumption characteristic for content items associated with the first rating group.

6. The apparatus of claim 1 further comprising a unit for adapting a number of recommendations included in the second set for a first rating group in response to a number of user ratings grouped in the first rating group.

7. The apparatus of claim 1 wherein the first recommendation unit is arranged to generate a set of content item recommendations for each rating group in response to content item data and user ratings of that rating group, and to generate the first set by combining the content item recommendations of the sets of content item recommendations for each rating group.

8. The apparatus of claim 1 further comprising a data storage for storing content items for which content item recommendations are included in the second set; and
a presentation unit arranged to present a content item from the data storage in response to a user selection of the content item.

9. The apparatus of claim 1 wherein the second recommendation unit is arranged to generate a preference value for a plurality of candidate content item selections from the first set and to select the second set as the candidate content item selection of the plurality of candidate content item selections having a highest preference value, the preference value for a candidate content item selection being a function of user ratings and a rating group distribution measure for content items of the candidate content item selection.

10. The apparatus of claim 1 further comprising a user interface for presenting content item recommendations from the second set, at least one presentation characteristic for a first content item recommendation being dependent on an associated user rating group for the first content item recommendation.

11. The apparatus of claim 1 further comprising a replacement unit arranged to replace, in the second set, a first content item consumed by a user by a second content item associated with a same rating group as the first content item

12. The apparatus of claim 1 wherein the user ratings comprise user ratings for a plurality of users.

13. The apparatus of claim 12 wherein the user ratings are anonymous.

14. The apparatus of claim 1 arranged to generate content item recommendations for a plurality of users and wherein the rating groups are common to a plurality of users

15. The apparatus of claim 1 wherein the content item match criterion comprises at least one of a content match criterion and a user preference indication match criterion.

16. A method of content item recommendation, the method comprising:
grouping user ratings for content items into rating groups in response to a content item match criterion;
receiving content item data for a plurality of content items;
generating a first set of content item recommendations;
determining an associated rating group of the rating groups for each content item recommendation of the first set; and
generating a second set of content item recommendations from the first set in response to a rating group distribution measure for the second set.
